(19) United States
(12) Patent Application Publication
(10) Pub. No.: US 2026/0368489 A1
(43) Pub. Date: Nov. 19, 2026

(54) SCREEN SURFACE ANOMALY DETECTION

(71) Applicant: STMicroelectronics International N.V., Geneva (CH)

(72) Inventor: Yi Wei YU, Shenzhen (CN)

(73) Assignee: STMicroelectronics International N.V., Geneva (CH)

(21) Appl. No.: 19/515,778

(22) PCT Filed: Sep. 7, 2023
(86) PCT No.: PCT/CN2023/117574

§ 371 Date: Mar. 2, 2026

(51) Int. Cl. G06N 3/0455

(52) U.S. Cl. CPC G06N 3/0455

(57) ABSTRACT

A method of detecting screen surface anomaly includes training a neural network model for detecting screen surface anomaly based on photon sensing, without requiring anomaly data, deploying the trained neural network model on an edge computing node integrated with at least one photon device, and causing performing of real-time detection of one or more anomalies on a screen surface using the trained neural network model and based on live data obtained from the at least one photon device.

### BACKGROUND

### Technical Field

The present disclosure relates to the field of surface defects detection.

The present disclosure relates more particularly to real-time detection of screen surface anomalies based on photon sensing and neural network processing.

### Description of the Related Art

Screen surface defect detection typically uses computer vision to simulate the function of human vision. The process can be complex, e.g., involving deep computer vision models (such as a neural network with a huge number of parameters) to process high resolution images of screen surfaces. Accordingly, significant computational power and memory requirement is typically needed to train or run the complex model, and an even higher requirement of computational resource is required to detect surface defects in real-time or near real-time. Typical computer vision-based detection technology also has stringent requirements (e.g., light intensity, lighting angle, or the like) for an associate optical system when building a detection platform for collecting data and feeding to the computer vision model.

All of the subject matter discussed in the Background section is not necessarily prior art and should not be assumed to be prior art merely as a result of its discussion in the Background section. Along these lines, any recognition of problems in the prior art discussed in the Background section or associated with such subject matter should not be treated as prior art unless expressly stated to be prior art. Instead, the discussion of any subject matter in the Background section should be treated as part of the inventor's approach to the particular problem, which, in and of itself, may also be inventive.

### BRIEF SUMMARY

In traditional industrial production and manufacturing, manual detection methods are still widely used to detect the defects on surface of products, which are prone to errors and can lead to inaccurate test results. Due to the huge demand for screen anomaly detection (e.g., in the recycling of mobile phone or other screen-based computing device), manual detection has become insufficient. In other application scenarios, such as exterior glass of buildings or special curved surfaces of products, it is impractical or impossible to directly apply manual inspection of the screen surfaces.

Automated screen surface defect detection typically uses computer vision to simulate the function of human vision. The process can be complex, e.g., involving deep computer vision models (such as a neural network with a huge number of parameters) to process high resolution images that capture screen surfaces. Accordingly, significant computational power and memory requirement is typically needed to train or run the complex model, and an even higher requirement of computational resource is required to detect surface defects in real-time or near real-time. Thus, high performance edge computing or cloud computing is usually needed. Typical computer vision-based detection technology also has stringent requirements (e.g., visible light intensity, lighting angle, or the like) for an associated optical system (e.g., including expensive industrial camera for high-resolution images) when building a detection platform for collecting data and feeding to the computer vision model.

To exacerbate the problem, computer vision models typically need to collect the pictures of surface defects as training data (e.g., to facilitate supervised learning with labeled data). However, when compared to the wide availability of products of normal screen, cracked or otherwise defect screens are rare, let alone the possibility to exhaust all kinds of surface anomalies. As such, training a comprehensive and robust computer vision model for screen surface anomaly detection can be difficult or impractical.

The presently disclosed technology is directed to the design and implementation of a low-cost, simple, and efficient screen surface anomaly detection framework applicable to a wide range of usage scenarios. Embodiments can provide significant savings on computational resource consumption (e.g., simple Autoencoder implementation on a microcontroller unit (MCU) or other relatively simplistic edge computing device) and on the associated optical system (e.g., using low-cost Time-of-Flight (ToF) systems). Embodiments can provide simpler and faster deployment, requiring a minimum amount of training data from normal screen surfaces. Embodiments further provide a wider range of application scenarios, requiring no visible light source. The presently disclosed technology can be used to detect small cracks in the screen, large-area broken screens, and/or other surface anomalies. Working in tandem with a planar sliding device or other position-aware device to set up a scanning platform, the presently disclosed technology can determine the location of surface anomalies, size of affected area, depth of anomaly, or the like.

Embodiments of the present disclosure provide a computer-implemented method of detecting screen surface anomaly. The method includes training a neural network model for detecting screen surface anomaly based on photon sensing, without requiring anomaly data; deploying the trained neural network model on an edge computing node integrated with at least one photon device; and causing performing of real-time detection of one or more anomalies on a screen surface using the trained neural network model and based on live data obtained from the at least one photon device.

Embodiments of the present disclosure provide a non-transitory computer-readable medium stores contents that cause one or more processors to perform actions. The actions include: implementing a trained neural network model on an edge computing node integrated with at least one photon device, wherein the neural network model is trained for detecting screen surface anomaly based on photon sensing, without requiring anomaly data; and performing real-time detection of one or more anomalies on a screen surface using the trained neural network model and based on live data obtained from the at least one photon device.

Embodiments of the present disclosure provide a system that includes one or more processors, and a computing device coupled to the one or more processors and configured to perform actions. The actions include: implementing a trained neural network model to integrate with at least one photon device, wherein the neural network model is trained for detecting screen surface anomaly based on photon sensing, without requiring anomaly data; and performing real-time detection of one or more anomalies on a screen surface using the trained neural network model and based on live data obtained from the at least one photon device.

### BRIEF DESCRIPTION OF THE SEVERAL VIEWS OF THE DRAWINGS

FIG. 1 is a block diagram of a working environment for surface anomaly detection, according to some embodiments.

FIG. 2 is a conceptual diagram illustrating photon sensing based surface anomaly detection, accordingly to some embodiments.

FIG. 3 is a flow diagram illustrating a process for a neural network based surface anomaly detection, according to some embodiments.

FIG. 4 is a block diagram illustrating elements of an example computing device or system utilized according to some embodiments.

FIG. 5 is a conceptual diagram illustrating an example autoencoder implementation of a neural network, according to some embodiments.

FIG. 6 illustrates an example of data obtained from one or more photon devices and a surface anomaly detected, according to some embodiments.

FIG. 7 shows an example of a scanning platform that integrates one or more photon devices and an edge computing node where a trained neural network is deployed, according to some embodiments.

### DETAILED DESCRIPTION

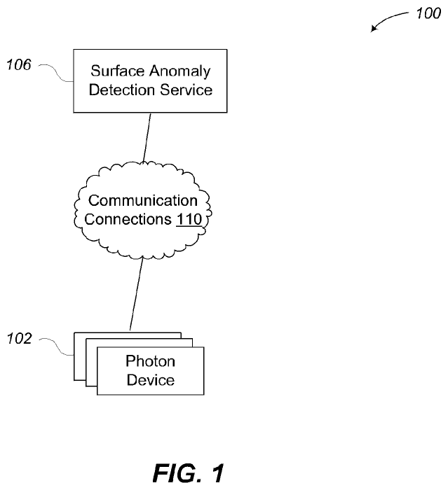

FIG. 1 is a block diagram of a working environment 100 for surface anomaly detection, according to some embodiments. The environment 100 includes one or more photon devices 102, which can be used to scan or otherwise interact with a target surface (e.g., a screen surface of a mobile phone, tablet, or notebook computer) by sensing photons, which may or may not be emitted by the photon device(s).

An example of the photon device 102 is a Time-of-Flight (ToF) device, which can include a singlezone or multizone ranging sensor. Illustratively, ToF is the measurement of the time taken by an object, particle, or wave to travel a distance through a medium. The example photon device 102 can include a single photon avalanche diode (SPAD) array, physical infrared filters, and diffractive optical elements (DOE) to achieve optimal or otherwise effective ranging performance in various ambient lighting conditions, e.g., with a range of cover glass materials. The use of a DOE above a vertical cavity surface emitting laser (VCSEL) can allow a square (or other shape) field of view (FoV) to be projected onto the target surface. The reflection of this light can be focused by the receiver lens onto a SPAD array. The ToF technology can allow absolute distance measurement regardless of the target color and reflectance. Illustratively, multizone distance measurements are up to 8×8 zones with a wide 63° diagonal FoV which can be reduced by software.

The photon device(s) 102 may communicate with the surface anomaly detection service 106 via communication connections 110. The communication connections 110 may include one or more computer networks, one or more wired or wireless networks, satellite transmission media, one or more cellular networks, or some combination thereof. The communication connections 110 may include a publicly accessible network of linked networks, possibly operated by various distinct parties, such as the Internet. The communication connections 110 may include other network types, such as one or more private networks (e.g., corporate or university networks that are wholly or partially inaccessible to non-privileged users), and may include combinations thereof, such that (for example) one or more of the private networks have access to and/or from one or more of the public networks. Furthermore, the communication connections 110 may include various types of wired and/or wireless networks in various situations, including satellite transmission. In addition, the communication connections 110 may include one or more communication interfaces including radio frequency (RF) transceivers, cellular communication interfaces and antennas, USB interfaces, ports and connections (e.g., USB Type-A, USB Type-B, USB Type-C (or USB-C), USB mini A, USB mini B, USB micro A, USB micro C), other RF transceivers (e.g., infrared transceivers, connection interfaces based on IEEE 802.15.4 Open Thread protocol, Zigbee® protocol, or IEEE 802.15.4 MAC layer, Z-Wave®) connection interfaces, wireless Ethernet (“Wi-Fi”) interfaces, short range wireless (e.g., Bluetooth®, Bluetooth® Low Energy (BLE)) interfaces or the like.

The surface anomaly detection service 106 can be cloud-based or otherwise implemented in a software and/or hardware form on one or more computing devices including a microcontroller unit (MCU), computer, mobile device, tablet computer, smart phone, handheld computer, and/or workstation, etc. In some embodiments, the surface anomaly detection service 106 is implemented partially or entirely on one or more photon devices 102. In some embodiments, the surface anomaly detection service 106 implements machine learning model(s) for anomaly detection. The machine learning model(s) can include neural networks, such as a network or circuit of biological neurons, or an artificial neural network composed of artificial neurons or nodes.

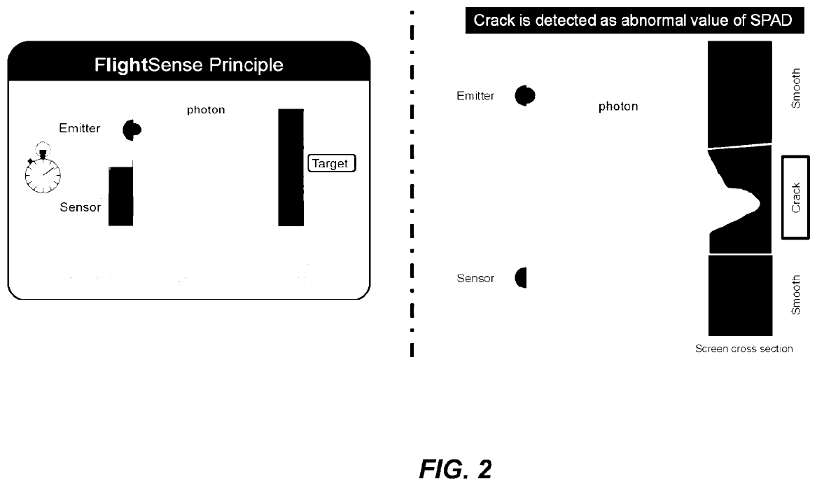

FIG. 2 is a conceptual diagram illustrating photon-sensing based surface anomaly detection, accordingly to some embodiments. The left side of FIG. 2 shows a photon device (e.g., a ToF device including SPAD) positioned relative to a normal target surface (e.g., a flat mirror screen of a mobile phone). The photon receiving sensor(s) (e.g., an 8×8 array of photon sensors) of the photon device receives a constant or approximately constant density of photons (e.g., at a refresh rate 16 Hz) that are emitted by photon emitter(s) (e.g., bourn by the photon device or separate) and reflected from the target surface. The right side of FIG. 2 shows that when a crack, break, scratch, chip, or other surface anomaly appears on the target surface, the density of photons received by the photon receiving sensor(s) changes (e.g., decreases due to misaligned reflections). Illustratively, at least some photons cannot travel back to the photon receiving sensor(s) through complete reflection by the target surface because the one or more surface anomalies change the reflection angle. Therefore, the signal energy of the photons received by the photon receiving sensor(s) is different than that with a normal, smooth target surface.

A ToF device can calculate the distance between the object reflecting the photon and the ToF device itself based on the photons received by the SPAD of its receiving array. However, in various embodiments of the presently disclosed technology, distance calculation is not needed or implemented; rather, raw data of the ToF device such as the received photon density of the SPAD (e.g., the number of photons in a refresh cycle) is obtained and used.

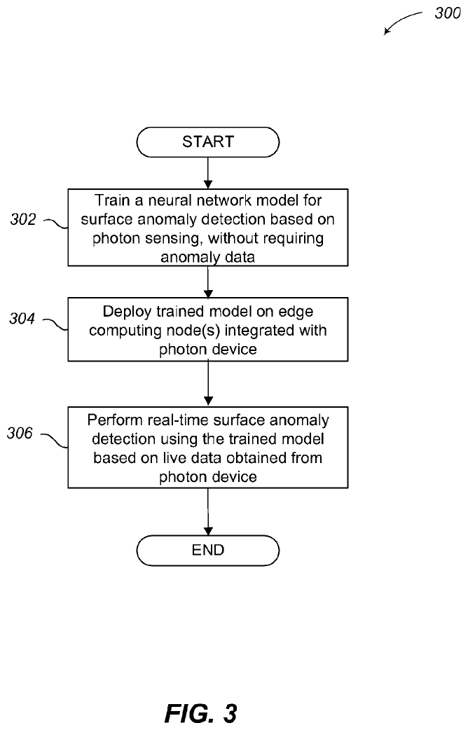

FIG. 3 is a flow diagram illustrating a process 300 for a neural network based surface anomaly detection, according to some embodiments. As discussed above, surface anomaly detection is based on signal energy change (e.g., photon density change) in photon sensing. It is difficult or impractical to simply set a threshold on the change, e.g., to detect SPAD outliers. Illustratively, this is because the possible value range of SPAD can be very wide (0~0x80000), different SPAD in the array facing the same screen may produce very different values (e.g., due to angles), and adjusting or optimizing the threshold may require a large quantity of target surface samples with anomalies (e.g., broken screens) which are difficult to obtain.

In accordance with various embodiments of the presently disclosed technology, accurate and effective detection of surface anomalies can be achieved through the training and deployment of an autoencoder neural network or other applicable unsupervised learning model. The training of the neural network does not require training data from surface anomalies, thereby overcoming the many difficulties associated with the obtaining of such surfaces. For example, the number of defective screens in normal production is very few, and it is even more impractical to ensure that the defective screens cover each type or situation of surface anomaly for training of a neural network. Instead, the presently disclosed technology can detect surface anomalies in operation by learning the photon reception conditions on a normal surface (e.g., a normal smooth screen). Surface anomalies can then be marked or labeled, and its position, width, length, size, depth or other contextual information can be calculated.

Illustratively, the process 300 can be implemented by the surface anomaly detection service 106, in part or in whole. In some embodiments, at least part of the process 300 is implemented by one or more photon devices 102. In some embodiments, at least part of the process 300 is performed in real-time relative to the scanning or other interactions with a target surface by one or more photon devices 102.

At block 302, the process 300 includes training a neural network model for detecting screen surface anomaly based on photon sensing. This can be done without requiring screen surface anomaly data (e.g., photon density or other reception conditions associated a target surface having anomalies).

The presently disclosed technology can include training the neural network model to recognize normal screen surfaces and detecting abnormalities based thereon. Illustratively, the neural network model can be an autoencoder capable of unsupervised learning of efficient codings from unlabeled data. The encoding is validated and refined by attempting to regenerate the input from the encoding. The autoencoder learns a representation (e.g., encoding) for a set of data, typically for dimensionality reduction, by training the network to ignore insignificant data (“noise”). Autoencoder can be used to detect abnormal value(s) when the input data is unexpected. Accordingly, normal screens can be used for photon-sensing data collection, which can be applied to neural network training, without the need for chipped, cracked, or broken screens. In some embodiments, the training data can be collected from a single normal screen, which can be adapted to all screens of the same type of product.

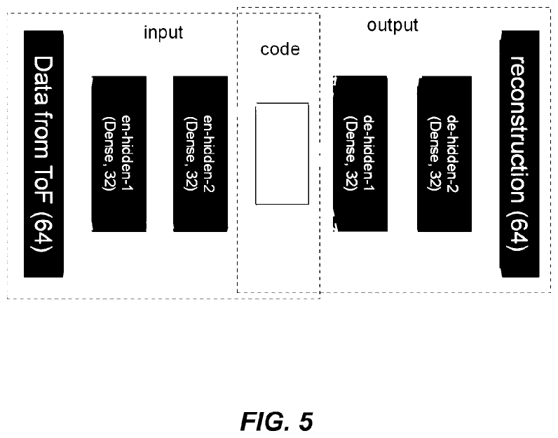

The neural network can be designed to be simple and efficient. FIG. 5 is a conceptual diagram illustrating an example autoencoder implementation of the neural network. Only a small amount of training data is needed to converge or otherwise stabilize the neural network and achieve solid results (e.g., with high accuracy where data from the output layer is similar to the data injected on the input layer). As an example, approximately 2 minutes of SPAD data (a total of 2,000 pieces of 8×8 SPAD array sensing data, generated at a refresh rate of 16 Hz) collected for a same normal screen is sufficient to train the autoencoder.

Referring back to FIG. 3, at block 304, the process 300 includes deploying the trained neural network model on one or more edge computing nodes. The edge computing node can be an MCU or other computing device, which may or may not be integrated with the photon device(s). The size of the trained neural network model may be sufficiently small to be accommodated by a memory of the edge computing node. Illustratively, the example autoencoder of FIG. 5 only needs 6.5 K parameters, and a regular MCU with typical computing power is sufficient to accommodate and execute the neural network.

At block 306, the process 300 includes performing surface anomaly detection in real-time using the trained neural network model based on live data obtained from the photon device(s). The live data obtained from the photon device(s) can indicate temporal change of signal energy within a field of view (FoV). The signal energy can be quantified by photon counts, photon density, or other photon related measures. The FoV can be a two-dimensional projection of multizone photons, which can form one or more squares, rectangles, triangles, circles, ellipses, combination of same or the like.

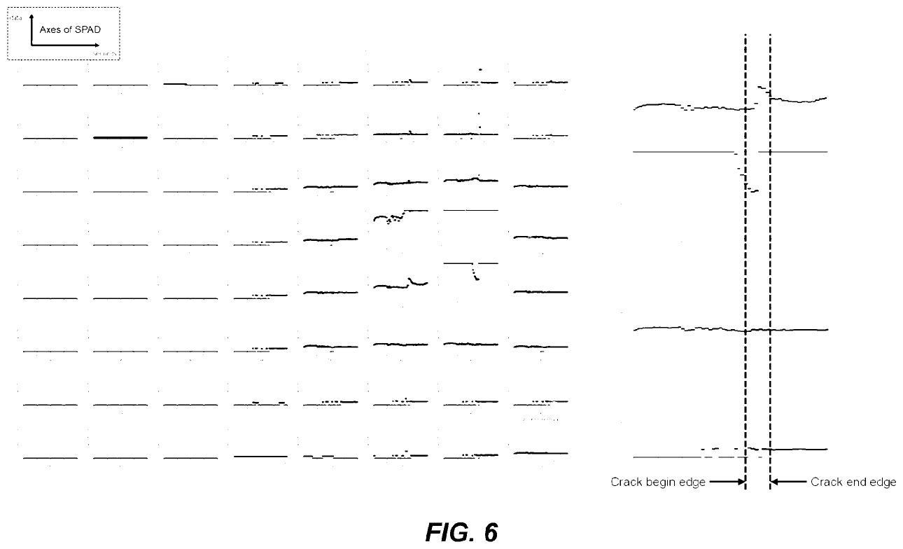

FIG. 6 illustrates an example of the data obtained from the photon device(s) and a surface anomaly detected. The left side of FIG. 6 shows an 8×8 array of photon sensing readings along a scanning path (e.g., a traversal over the target screen surface based on axes of SPAD). The right side of FIG. 6 partially illustrates the detection of a crack using the trained neural network model, which takes the photon sensing data, as generated live by the photon device(s), as input. The detection can be more obvious and dependent on some photon sensing readings than others in the array. The detected anomaly can correspond to a begin edge and an end edge with respect to the scanning path, which can be used to calculate the location, size, or other characteristic of the surface anomaly.

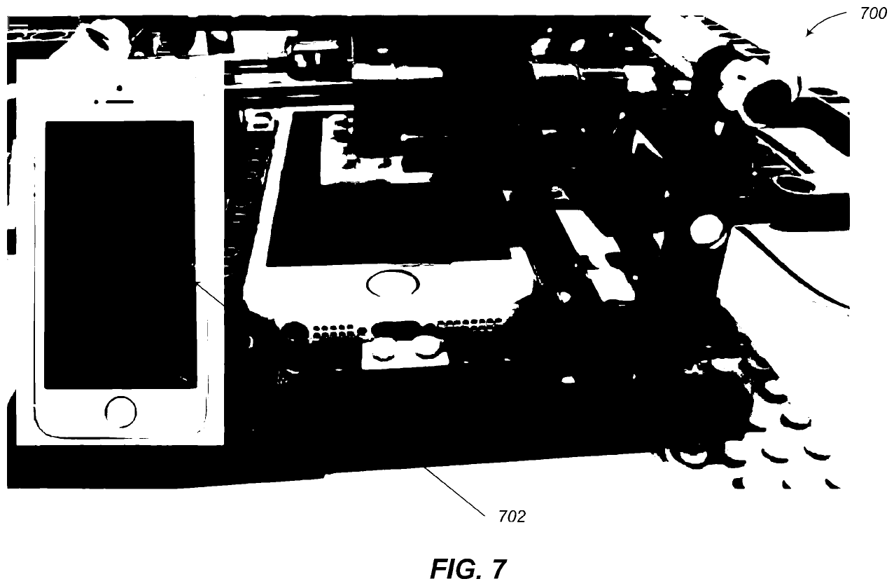

FIG. 7 shows an example of a scanning platform 700 that integrates one or more photon devices and an edge computing node where a trained neural network is deployed. The edge computing node can further calculate or otherwise determine the location, size, or other characteristic of an anomaly 702 detected on a target surface (e.g., a mobile phone screen) in real-time relative to the scanning of the target surface along a scanning path.

Those skilled in the art will appreciate that the various operations depicted via FIG. 3, as well as those described elsewhere herein, may be altered in a variety of ways. For example, the particular order of the operations may be rearranged; some operations may be performed in parallel; shown operations may be omitted, or other operations may be included; a shown operation may be divided into one or more component operations, or multiple shown operations may be combined into a single operation, etc.

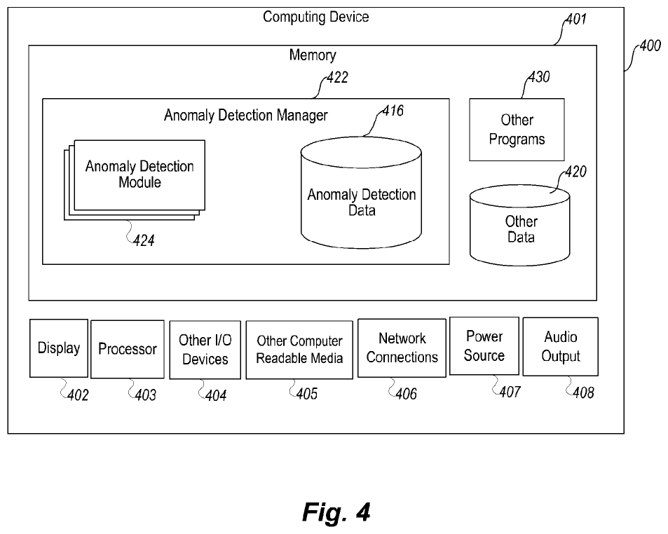

FIG. 4 is a block diagram illustrating elements of an example computing device or system 400 utilized in accordance with some embodiments of the techniques described herein. Illustratively, the computing device 400 corresponds to a computing device implementing the surface anomaly detection service 106, or at least a part thereof.

In some embodiments, one or more general purpose or special purpose computing systems or devices may be used to implement the computing device 400. In addition, in some embodiments, the computing device 400 may comprise one or more distinct computing systems or devices, and may span distributed locations. Furthermore, each block shown in FIG. 4 may represent one or more such blocks as appropriate to a specific embodiment or may be combined with other blocks. Also, the anomaly detection manager 422 may be implemented in software, hardware, firmware, or in some combination to achieve the capabilities described herein.

As shown, the computing device 400 comprises a computer memory (“memory”) 401, a display 402 (including, but not limited to a light emitting diode (LED) panel, cathode ray tube (CRT) display, liquid crystal display (LCD), touch screen display, projector, etc.), one or more Central Processing Units (CPU) or other processors 403, Input/Output (I/O) devices 404 (e.g., keyboard, mouse, RF or infrared receiver, universal serial bus (USB) ports, High-Definition Multimedia Interface (HDMI) ports, other communication ports, and the like), other computer-readable media 405, network connections 406, a power source (or interface to a power source) 407, and audio output 408 (including, but not limited to speakers, buzzers, handphones, etc.). The anomaly detection manager 422 is shown residing in memory 401. In other embodiments, some portion of the contents and some, or all, of the components of the anomaly detection manager 422 may be stored on and/or transmitted over the other computer-readable media 405. The components of the computing device 400 and anomaly detection manager 422 can execute on one or more processors 403 and implement applicable functions described herein. In some embodiments, the anomaly detection manager 422 may operate as, be part of, or work in conjunction and/or cooperation with other software applications stored in memory 401 or on various other computing devices. In some embodiments, the anomaly detection manager 422 also facilitates communication with peripheral devices via the I/O devices 404, or with another device or system via the network connections 406.

The one or more anomaly detection modules 424 is configured to perform actions related, directly or indirectly, to the photon data obtaining, model training, model deployment, surface anomaly detection, or other functions described herein. In some embodiments, the anomaly detection module(s) 424 stores, retrieves, or otherwise accesses at least some anomaly detection-related data on some portion of the anomaly detection data storage 416 or other data storage internal or external to the computing device 400. In various embodiments, at least some of the anomaly detection modules 424 may be implemented in software or hardware.

Other code or programs 430 (e.g., further data processing modules, communication modules, a Web server, and the like), and potentially other data repositories, such as data repository 420 for storing other data, may also reside in the memory 401, and can execute on one or more processors 403. Of note, one or more of the components in FIG. 4 may or may not be present in any specific implementation. For example, some embodiments may not provide other computer readable media 405, a display 402, or audio output 408.

In some embodiments, the computing device 400 and anomaly detection manager 422 include API(s) that provides programmatic access to add, remove, or change one or more functions of the computing device 400. In some embodiments, components/modules of the computing device 400 and anomaly detection manager 422 are implemented using standard programming techniques. For example, the anomaly detection manager 422 may be implemented as an executable running on the processor(s) 403, along with one or more static or dynamic libraries. In other embodiments, the computing device 400 and anomaly detection manager 422 may be implemented as instructions processed by a virtual machine that executes as one of the other programs 430. In general, a range of programming languages known in the art may be employed for implementing such example embodiments, including representative implementations of various programming language paradigms, including but not limited to, object-oriented (e.g., Java, C++, C #, Visual Basic. NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), or declarative (e.g., SQL, Prolog, and the like).

In a software or firmware implementation, instructions stored in a memory configure, when executed, one or more processors of the computing device 400 to perform the functions of the anomaly detection manager 422. In some embodiments, instructions cause the one or more processors 403 or some other processor(s), such as an I/O controller/processor, to perform at least some functions described herein.

The embodiments described above may also use well-known or other synchronous or asynchronous client-server computing techniques. However, the various components may be implemented using more monolithic programming techniques as well, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs or other processors. Some embodiments may execute concurrently and asynchronously, and communicate using message passing techniques. Equivalent synchronous embodiments are also supported by a anomaly detection manager 422 implementation. Also, other functions could be implemented and/or performed by each component/module, and in different orders, and by different components/modules, yet still achieve the functions of the computing device 400 and anomaly detection manager 422.

In addition, programming interfaces to the data stored as part of the computing device 400 and anomaly detection manager 422, can be available by standard mechanisms such as through C, C++, C #, and Java APIs; libraries for accessing files, databases, or other data repositories; scripting languages such as XML; or Web servers, FTP servers, NFS file servers, or other types of servers providing access to stored data. The anomaly detection data storage 416 and data repository 420 may be implemented as one or more database systems, file systems, or any other technique for storing such information, or any combination of the above, including implementations using distributed computing techniques.

Different configurations and locations of programs and data are contemplated for use with techniques described herein. A variety of distributed computing techniques are appropriate for implementing the components of the illustrated embodiments in a distributed manner including but not limited to TCP/IP sockets, RPC, RMI, HTTP, and Web Services (XML-RPC, JAX-RPC, SOAP, and the like). Other variations are possible. Other functionality could also be provided by each component/module, or existing functionality could be distributed amongst the components/modules in different ways, yet still achieve the functions of the anomaly detection manager 422.

Furthermore, in some embodiments, some or all of the components of the computing device 400 and anomaly detection manager 422 may be implemented or provided in other manners, such as at least partially in firmware and/or hardware, including, but not limited to one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), and the like. Some or all of the system components and/or data structures may also be stored as contents (e.g., as executable or other machine-readable software instructions or structured data) on a computer-readable medium (e.g., as a hard disk; a memory; a computer network, cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use, or provide the contents to perform, at least some of the described techniques.

In some embodiments, a computer-implemented method of detecting screen surface anomaly includes deploying a trained neural network model on an edge computing node integrated with at least one photon device, wherein the trained neural network model comprises an autoencoder trained without requiring screen surface anomaly data; and causing performing of real-time detection of one or more anomalies on a screen surface using the trained neural network model and based on live data obtained from the at least one photon device.

In some embodiments, the screen surface includes a screen surface of at least one of a mobile phone, tablet, or notebook computer. In some embodiments, the one or more anomalies include at least one of a crack, scratch, or chip. In some embodiments, the size of the trained neural network model is sufficiently small to be accommodated by a memory of the edge computing node.

In some embodiments, the live data obtained from the at least one photon device indicates temporal change of signal energy within a field of view. In some embodiments, the signal energy is quantified by photon counts. In some embodiments, the field of view includes a two-dimensional projection of multizone photons.

In some embodiments, the photon device includes at least one of visible or invisible light source for photon emission.

In some embodiments, a non-transitory computer-readable medium stores contents that cause one or more processors to perform actions. The actions include: implementing a trained neural network model on an edge computing node integrated with at least one photon device, wherein the neural network model is trained for detecting screen surface anomaly based on photon sensing, without requiring anomaly data; and performing real-time detection of one or more anomalies on a screen surface using the trained neural network model and based on live data obtained from the at least one photon device.

In some embodiments, the screen surface includes a screen surface of at least one of a mobile phone, tablet, or notebook computer. In some embodiments, the one or more anomalies include at least one of a crack, scratch, or chip. In some embodiments, the size of the trained neural network model is sufficiently small to be accommodated by a memory of the edge computing node.

In some embodiments, the live data obtained from the at least one photon device indicates temporal change of signal energy within a field of view. In some embodiments, the signal energy is quantified by photon counts. In some embodiments, the field of view includes a two-dimensional projection of multizone photons.

In some embodiments, the photon device includes at least one of visible or invisible light source for photon emission.

In some embodiments, a system includes one or more processors, and a computing device coupled to the one or more processors and configured to perform actions. The actions include: implementing a trained neural network model to integrate with at least one photon device, wherein the neural network model is trained for detecting screen surface anomaly based on photon sensing, without requiring anomaly data; and performing real-time detection of one or more anomalies on a screen surface using the trained neural network model and based on live data obtained from the at least one photon device.

In some embodiments, the screen surface includes a screen surface of at least one of a mobile phone, tablet, or notebook computer. In some embodiments, the one or more anomalies include at least one of a crack, scratch, or chip. In some embodiments, the size of the trained neural network model is sufficiently small to be accommodated by a memory of the computing device.

In some embodiments, the live data obtained from the at least one photon device indicates temporal change of signal energy within a field of view. In some embodiments, the signal energy is quantified by photon counts. In some embodiments, the field of view includes a two-dimensional projection of multizone photons.

In some embodiments, the photon device includes at least one of visible or invisible light source for photon emission.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A computer-implemented method of detecting screen surface anomaly, the method comprising:
deploying a trained neural network model on an edge computing node integrated with at least one photon device, wherein the trained neural network model comprises an autoencoder trained without requiring screen surface anomaly data; and
causing performing of real-time detection of one or more anomalies on a screen surface using the trained neural network model and based on live data obtained from the at least one photon device.

2. The method of claim 1, wherein the screen surface includes a screen surface of at least one of a mobile phone, tablet, or notebook computer.

3. The method of claim 1, wherein the one or more anomalies include at least one of a crack, scratch, or chip.

4. The method of claim 1, wherein the size of the trained neural network model is sufficiently small to be accommodated by a memory of the edge computing node.

5. The method of claim 1, wherein the live data obtained from the at least one photon device indicates temporal change of signal energy within a field of view.

6. The method of claim 5, wherein the signal energy is quantified by photon counts.

7. The method of claim 5, wherein the field of view includes a two-dimensional projection of multizone photons.

8. The method of claim 1, wherein the photon device includes at least one of visible or invisible light source for photon emission.

9. A non-transitory computer-readable medium storing contents that cause one or more processors to perform actions comprising:
implementing a trained neural network model on an edge computing node integrated with at least one photon device, wherein the neural network model is trained for detecting screen surface anomaly based on photon sensing, without requiring anomaly data; and
performing real-time detection of one or more anomalies on a screen surface using the trained neural network model and based on live data obtained from the at least one photon device.

10. (canceled)

11. The computer-readable medium of claim 9, wherein the one or more anomalies include at least one of a crack, scratch, or chip.

12. The computer-readable medium of claim 9, wherein the size of the trained neural network model is sufficiently small to be accommodated by a memory of the edge computing node.

13. The computer-readable medium of claim 9, wherein the live data obtained from the at least one photon device indicates temporal change of signal energy within a field of view.

14. The computer-readable medium of claim 13, wherein the signal energy is quantified by photon counts.

15. The computer-readable medium of claim 13, wherein the field of view includes a two-dimensional projection of multizone photons.

16. (canceled)

17. A system, comprising:
one or more processors; and
a computing device coupled to the one or more processors and configured to perform actions comprising:
implementing a trained neural network model to integrate with at least one photon device, wherein the neural network model is trained for detecting screen surface anomaly based on photon sensing, without requiring anomaly data; and
performing real-time detection of one or more anomalies on a screen surface using the trained neural network model and based on live data obtained from the at least one photon device.

18. (canceled)

19. The system of claim 17, wherein the one or more anomalies include at least one of a crack, scratch, or chip.

20. The system of claim 17, wherein the size of the trained neural network model is sufficiently small to be accommodated by a memory of the computing device.

21. The system of claim 17, wherein the live data obtained from the at least one photon device indicates temporal change of signal energy within a field of view.

22. The system of claim 21, wherein the signal energy is quantified by photon counts.

23. The system of claim 21, wherein the field of view includes a two-dimensional projection of multizone photons.

24. (canceled)
